(19) United States
(12) Patent Application Publication
(10) Pub. No.: US 2016/0061386 A1
(43) Pub. Date: Mar. 3, 2016

(54) Light-emitting diode bulb

(71) Applicant: YU-SYUAN CHEN, New Taipei City (TW)

(72) Inventor: YU-SYUAN CHEN, New Taipei City (TW)

(21) Appl. No.: 14/475,587

(22) Filed: Sep. 3, 2014

(51) Int. Cl. F21K 99/00; F21V 23/02; F21V 29/00

(52) U.S. Cl. CPC F21K 9/13; F21V 29/2206; F21V 29/2231; F21V 23/02

(57) ABSTRACT

A light-emitting diode bulb is electrically connected with a bulb holder and contains: an electrical fitting electrically connecting with the bulb holder and including a first electricity conducting portion, a second electricity conducting portion electrically insulated from the first electricity conducting portion by an electricity insulating portion, and at least one electrode orifice; an illuming assembly including a circuit board and a plurality of light-emitting diodes, the circuit board having a printed circuit, a first circuit contact, and a second circuit contact; a circuit module including an electrical driving board, a driving circuit portion, a first input electrode contact, a second input electrode contact, a first output electrode contact, and a second output electrode contact. The first output electrode contact and the second output electrode contact are electrically connected with a first circuit contact and a second circuit contact of the illuming assembly.

### FIELD OF THE INVENTION

The present invention relates to a light-emitting diode lighting device, and more particularly to a light-emitting diode bulb which is produced easily and quickly.

### BACKGROUND OF THE INVENTION

A light-emitting diode is driven by direct current, so a conventional light-emitting diode bulb contains a conversion circuit for converting alternating current into the direct current to drive the light-emitting diode. Since the light-emitting diode is broken at high temperature, and the light-emitting diode bulb also contains plural dissipating fins for dissipating heat of the light-emitting diode bulb to avoid a damage of the light-emitting diode bulb at the high temperature. Preferably, the light-emitting diode bulb is electrically connected with a bulb holder by using the conversion circuit.

For example, another conventional light-emitting diode bulb is disclosed in TW Patent No. I384170 and contains a dissipating casing, a metal cap, a driving circuit board, an illuminating piece, a gasket, and a lampshade. The dissipating casing includes an opening defined on a first end thereof and a connecting hole formed on a second end thereof. The metal cover is fixed on the connecting hole of the dissipating casing, and the driving circuit board is mounted in the dissipating casing and is electrically connected with the metal cap. The illuminating piece and the gasket are arranged in the opening, such that the illuminating piece is electrically coupled with the driving circuit board. A modular light emitting diode bulb is disclosed in TW Patent No. 455988 and contains: a lampshade, an illuminating plate printed an electric circuit and having plural light-emitting diode covering elements, a light cap, a bulb holder, and a driving module printed an electric circuit and electrically connected with a plurality of electronic components; wherein the illuminating plate has a female joining seat; the light cap has a first opening end, a second open end, and a screwing portion; the bulb holder has a connecting element, an insulating element, and a contacting element; the driving module has a male joining seat, a ground wire, and a live wire; the first open end of the light cap is covered on the illuminating plate, the female joining seat is in connection with the male joining seat, the ground wire contacts with the contacting element of the bulb holder, the live wire contacts with the contacting element of the bulb holder, and the contacting element is screwed with the screwing portion of the light cap.

However, the modular light emitting diode bulb is produced complicatedly and troublesomely.

The present invention has arisen to mitigate and/or obviate the afore-described disadvantages.

### SUMMARY OF THE INVENTION

The primary object of the present invention is to provide a light-emitting diode bulb which is produced easily and quickly

To obtain the above objective, a light-emitting diode bulb provided by the present invention is electrically connected with a bulb holder and contains:

an electrical fitting electrically connecting with the bulb holder and including a first electricity conducting portion and a second electricity conducting portion electrically insulated from the first electricity conducting portion by an electricity insulating portion, the first electricity conducting portion and the second electricity conducting portion being electrically coupled with two power contacts, the electrical fitting also including at least one electrode orifice for inserting the first electricity conducting portion or the second electricity conducting portion;

an illuming assembly including a circuit board and a plurality of light-emitting diodes, the circuit board having a printed circuit electrically connected with the plurality of light-emitting diodes, and a first circuit contact and a second circuit contact which are both arranged on the printed circuit to conduct power to illuminate the plurality of light-emitting diodes;

a circuit module including an electrical driving board, a driving circuit portion formed on the electrical driving board, a first input electrode contact, a second input electrode contact, a first output electrode contact, and a second output electrode contact, the driving circuit portion being employed to convert the power and to control the power, such that the power of the bulb holder is transformed to illuminate the plurality of light-emitting diodes, one of the first input electrode contact and the second input electrode contact being inserted into the at least one electrode orifice of the electrical fitting and extending out of the electrical fitting to conduct the power, the other of the first input electrode contact and the second input electrode contact being electrically coupled with one of the first electricity conducting portion and the second electricity conducting portion which does not have the at least one electrode orifice, wherein the first output electrode contact and the second output electrode contact are electrically connected with a first circuit contact and a second circuit contact of the illuming assembly.

### BRIEF DESCRIPTION OF THE DRAWINGS

FIG. 1 is a perspective view of the exploded components of light-emitting diode bulb according to a first embodiment of the present invention.

FIG. 2 is a cross sectional view of the assembly of light-emitting diode bulb according to the first embodiment of the present invention.

FIG. 3 is a perspective view of the exploded components of light-emitting diode bulb according to a second embodiment of the present invention.

FIG. 4 is a perspective view of the exploded components of light-emitting diode bulb according to a third embodiment of the present invention.

FIG. 5 is a cross sectional view of the assembly of light-emitting diode bulb according to the third embodiment of the present invention.

FIG. 6 is a cross sectional view of the assembly of light-emitting diode bulb according to a fourth embodiment of the present invention.

FIG. 7 is a cross sectional view of the assembly of light-emitting diode bulb according to a fifth embodiment of the present invention.

FIG. 8 is a cross sectional view of the assembly of light-emitting diode bulb according to a sixth embodiment of the present invention.

### DETAILED DESCRIPTION OF THE PREFERRED EMBODIMENTS

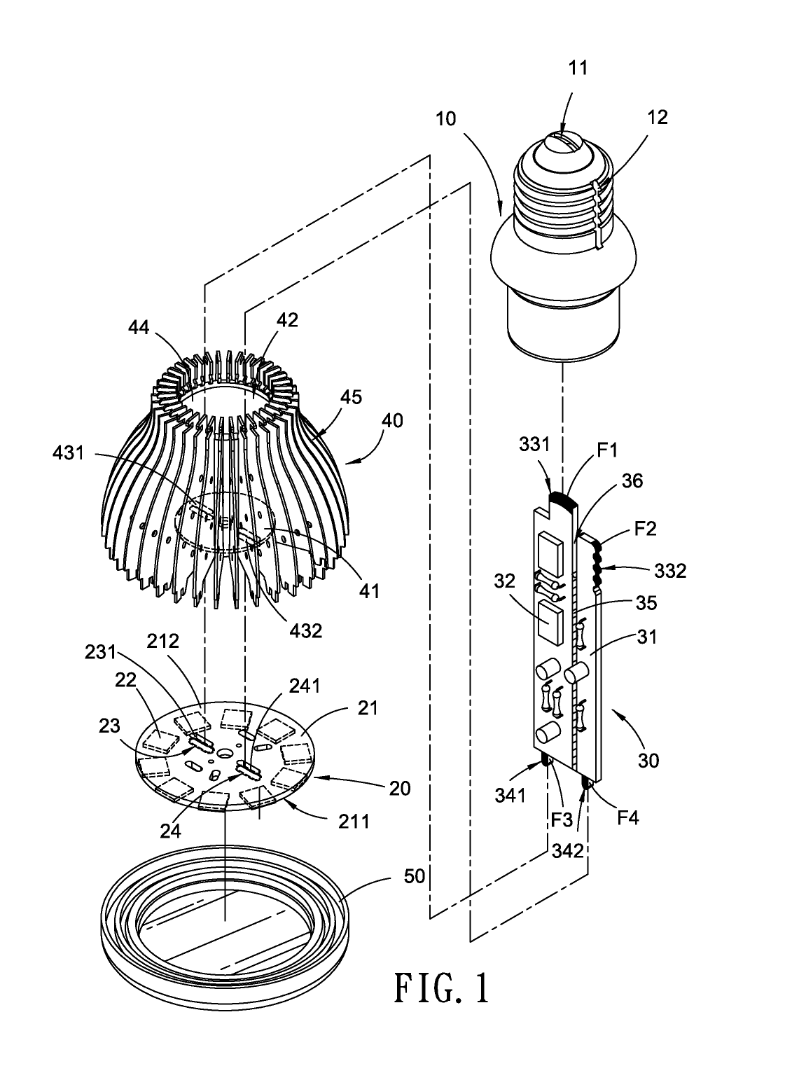

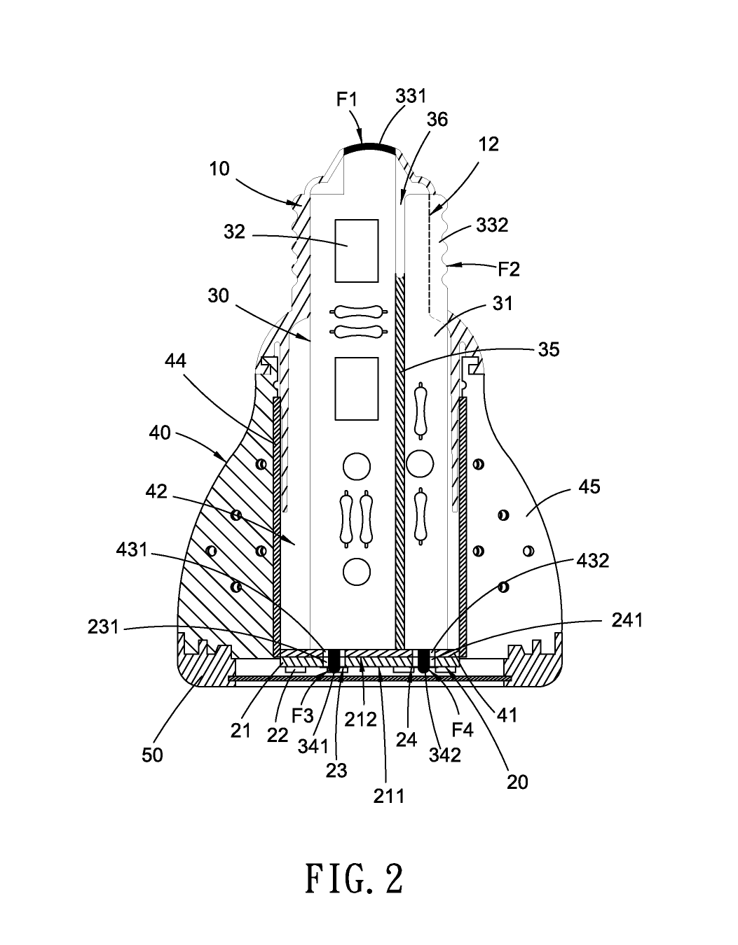

FIGS. 1 and 2, a light-emitting diode bulb 100 according to a first embodiment of the present invention comprises: an electrical fitting 10, an illuming assembly 20, and a circuit module 30.

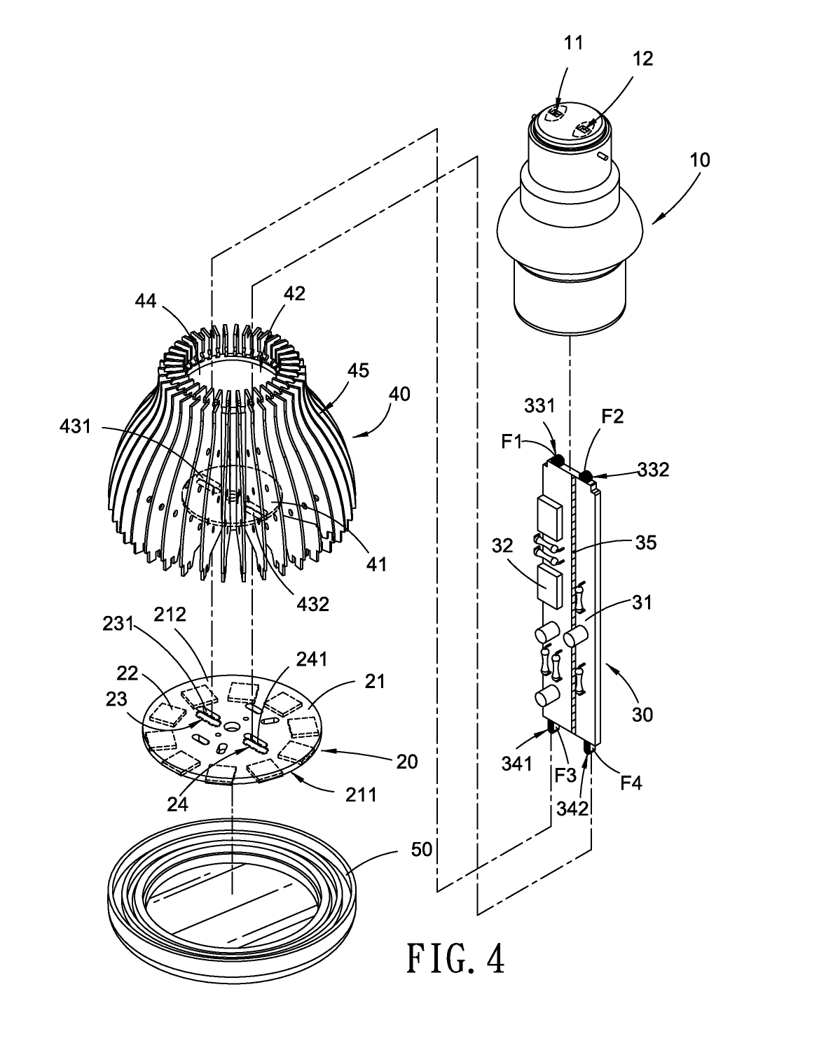

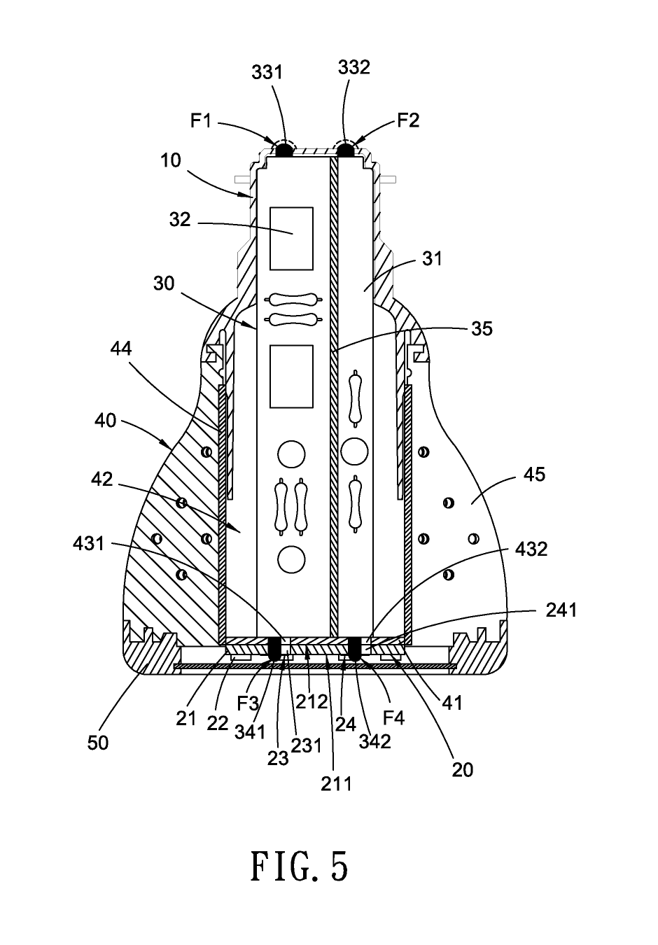

The electrical fitting 10 is electrically connected with a bulb holder (not shown) which is coupled with a power supply, wherein the electrical fitting 10 is an Edison screw cap (such as E22, E26 or E27, as shown in FIG. 1) or a Bayonet cap (such as B22 or GU 10, as shown in FIGS. 4 and 5) in a third embodiment of the present invention.

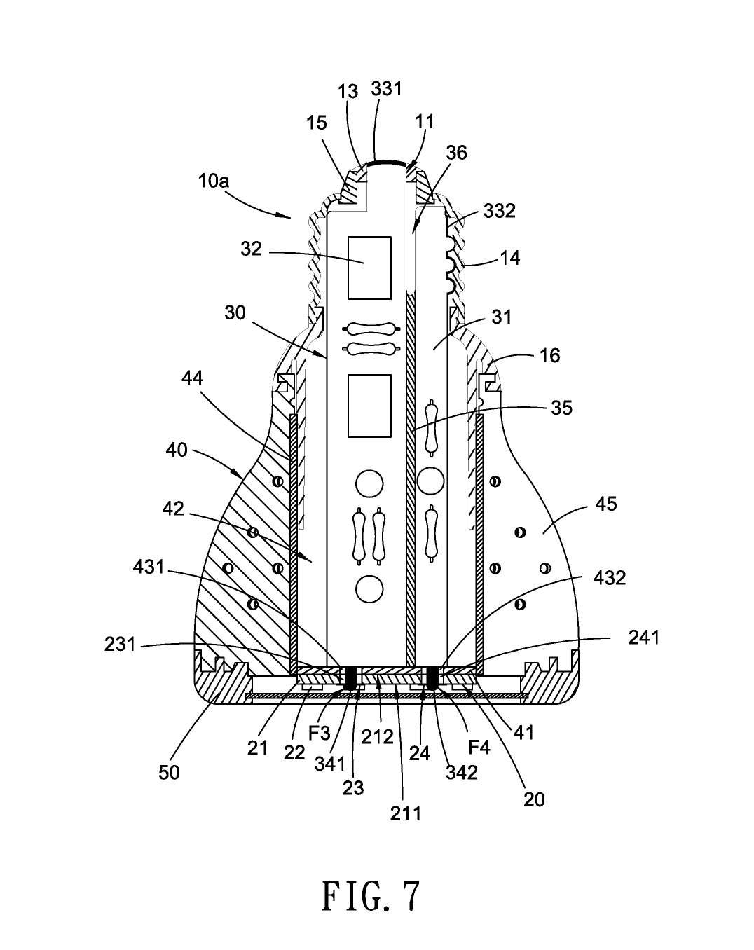

The electrical fitting 10 includes a first electrode orifice 11 and a second electrode orifice 12 which are both defined in the electrical fitting 10 and correspond to two power contacts (such as a ground contact and a wire contact of AC power supply or a positive electrode and a negative electrode of DC power supply) of the bulb holder. Preferably, the electrical fitting 10 is an electrical insulating element one piece formed from electrical plastic material, such as polycarbonate (PC). As shown in FIG. 1, the electrical fitting 10 is one-piece injection molded from polycarbonate (PC) to enhance production efficiency. Referring to FIG. 7, in a fifth embodiment, an electrical fitting 10a includes a first electricity conducting portion 13 and a second electricity conducting portion 14 electrically insulated from the first electricity conducting portion 13 by an electricity insulating portion 15. The electrical fitting 10a also includes an electrically isolative connecting sleeve 16 retained with a bottom end of the second electricity conducting portion 14. After the electrical fitting 10a is connected with the bulb holder, the first electricity conducting portion 13 and the second electricity conducting portion 14 are electrically coupled with two power contacts (such as a ground contact and a wire contact of AC power supply or a positive electrode and a negative electrode of DC power supply) of the bulb holder. In addition, the first electricity conducting portion 13 has a first electrode orifice 11 defined therein, and the second electricity conducting portion 14 has a second electrode orifice 12 defined therein.

With reference to FIGS. 1 and 2, the illuming assembly 20 includes a circuit board 21 and a plurality of light-emitting diodes 22. The circuit board 21 has a printed circuit electrically connected with the plurality of light-emitting diodes 22, and a first circuit contact 23 and a second circuit contact 24 which are both arranged on the printed circuit to conduct power to illuminate the plurality of light-emitting diodes 22, wherein the plurality of light-emitting diodes 22 are arranged on a bottom face 211 of the circuit board 21, and the circuit board 21 also has a first through hole 231 for corresponding to the first circuit contact 23 and has a second through hole 241 for corresponding to the second circuit contact 24.

The circuit module 30 includes an electrical driving board 31, a driving circuit portion 32 formed on the electrical driving board 31, at least one input electrode contact, and at least one output electrode contact which are both configured on the electrical driving board 31. The driving circuit portion 32 has electronic components and a printed circuit electrically connected with the electronic components, and the driving circuit portion 32 is employed to convert the power (such as converting alternative current into direct current or converting direct current into alternative current) and to control the power (such as transforming voltage, stabilizing voltage or controlling constant current), such that the power of the bulb holder is transformed to illuminate the plurality of light-emitting diodes 22, and the at least one input electrode contact is electrically connected with the driving circuit portion 32 to input the power, and the at least one output electrode contact is electrically connected with the driving circuit portion 32 to output the power. The at least one input electrode contact has a first input electrode contact 331 and a second input electrode contact 332, wherein the first input electrode contact 331 and the second input electrode contact 332 are a first protrusion and a second protrusion which are both formed on a first end of the electrical driving board 31, the first protrusion has a first edge F1, and the second protrusion has a second edge F2. Preferably, the first protrusion of the first input electrode contact 331 and the second protrusion of the second input electrode contact 332 are electrically connected with the driving circuit portion 32 by ways of a conductive metal layer, the printed circuit of the driving circuit portion, a solder area or a metal guiding sheet. Furthermore, the electrical driving board 31 has an insulation portion 35 (such as insulation paint) formed thereon to isolate the power from the first input electrode contact 331 and the second input electrode contact 332, wherein extending portions of the first input electrode contact 331 and the second input electrode contact 332 are extended out of the first electrode orifice 11 and the second electrode orifice 12 of the electrical fitting 10 and are weld solders thereon, such that when the electrical fitting 10 is in connection with the bulb holder, the first input electrode contact 331 and the second input electrode contact 332 are electrically connected with the two power contacts of the bulb holder to further electrically couple with the power.

The electrical driving board 31 also has a slit 36 defined in the first input electrode contact 331 and the second input electrode contact 332 (as illustrated in FIG. 1) to provide a deformable space to the first input electrode contact 331 and the second input electrode contact 332, such that the first input electrode contact 331 is inserted into the first electrode orifice 11, and the second input electrode contact 332 is inserted into the second electrode orifice 12.

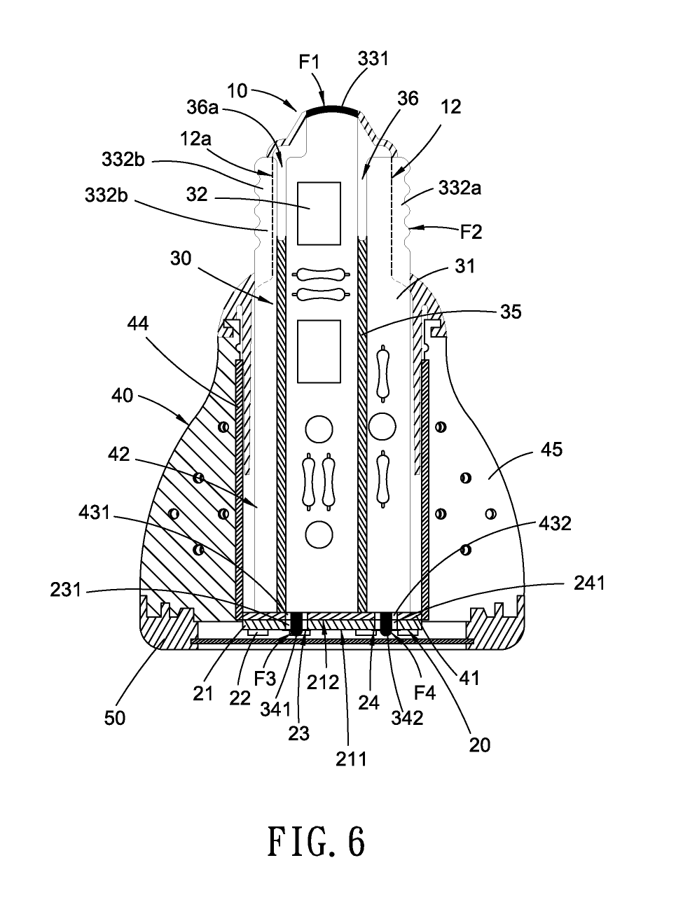

In a fourth embodiment, as shown in FIG. 6, an electrical driving board 31 has a first input electrode contact 331 and two second input electrode contacts 332a, 332b arranged on two opposite positions of the first input electrode contact 331, wherein two slits 36, 36a are defined among the first input electrode contact 331 and the two second input electrode contacts 332a, 332b to provide two deformable spaces to the first input electrode contact 331 and the two second input electrode contacts 332a, 332b. Moreover, the electrical driving board 31 also has two insulation portions 35 formed thereon to isolate the power from the first input electrode contact 331 and the two input second electrode contacts 332a, 332b, wherein an electrical fitting 10 includes a second electrode orifice 12a for corresponding to one of the two second input electrode contacts 332b, such that the one of the two second input electrode contacts 332b extend out of the electrical fitting 10 to conduct the power.

As shown in FIGS. 1 and 2, a first output electrode contact 341 and a second output electrode contact 342 are a third protrusion and a fourth protrusion which are both formed on a second end of the electrical driving board 31, the third protrusion has a third edge F3, and the fourth protrusion has a fourth edge F4. Preferably, the third protrusion of the first output electrode contact 341 and the fourth protrusion of the second output electrode contact 342 are electrically connected with the driving circuit portion 32 by ways of the conductive metal layer or the printed circuit of the electrical driving board 31. The first output electrode contact 341 and the second output electrode contact 342 are inserted into the first through hole 231 and the second through hole 241 of the illuming assembly 20, wherein the first output electrode contact 341 and the second output electrode contact 342 are solder welded with the first circuit contact 23 and the second circuit contact 24, such that the power is conducted to a printed circuit (not shown) of the illuming assembly 20, and the plurality of light-emitting diodes 22 is driven by the power to illuminate.

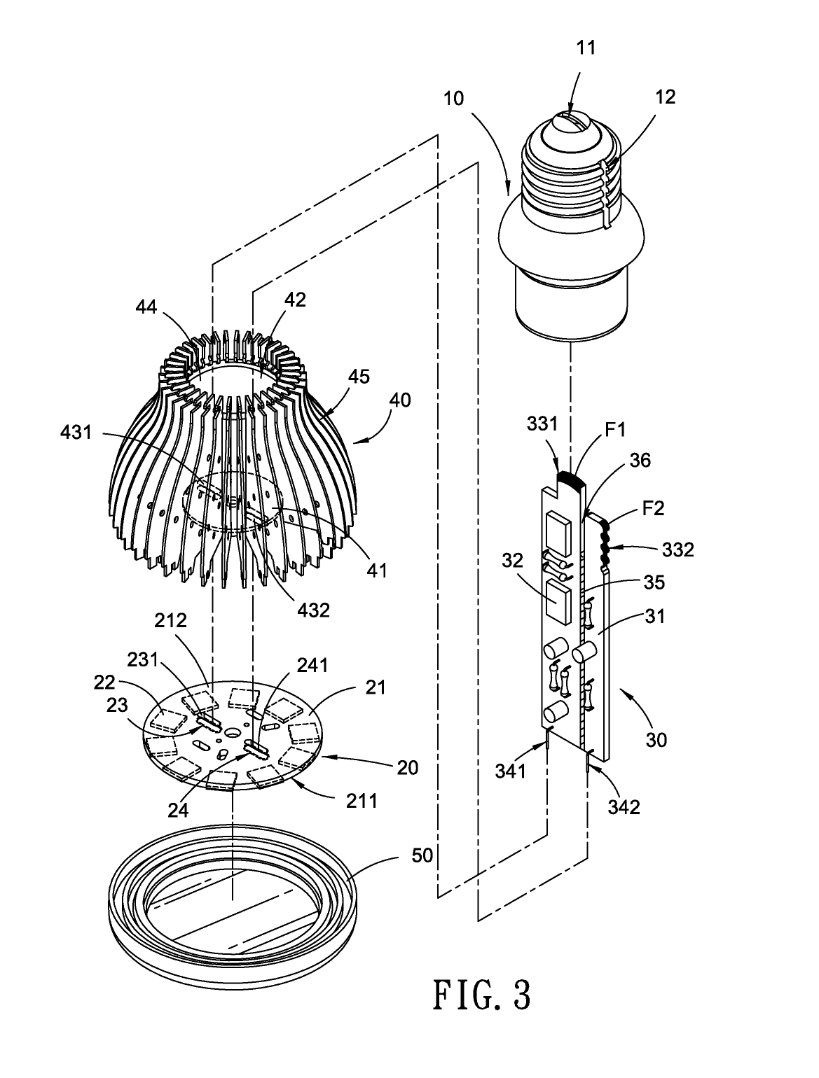

Referring to FIG. 3, in a second embodiment, a first output electrode contact 341 and a second output electrode contact 342 are arranged adjacent to a second end of the electrical driving board 31 and are electrically connected with the driving circuit portion 32 by ways of metal terminals or metal pins. The first output electrode contact 341 and the second output electrode contact 342 are welded with the first circuit contact 23 and the second circuit contact 24, such that the power is conducted to a printed circuit (not shown) of the illuming assembly 20, such that the plurality of light-emitting diodes 22 is driven by the power to illuminate.

The light-emitting diode bulb further comprises a radiating assembly 40 extrusion molded from aluminum, and the radiating assembly 40 includes a heat guiding plate 41, a hollow room 42, and an accommodating tube 44 fixed in the hollow room 42, wherein the electrical fitting 10 is mounted on one end of the radiating assembly 40, the circuit module 30 is inserted into the hollow room 42, and the circuit board 21 of the illuming assembly 20 is joined with the heat guiding plate 41, such that heat of the illuming assembly 20 is dissipated via the heat guiding plate 41. In addition, a top face 212 of the circuit board 21, on which a plurality of light-emitting diodes 22 are arranged, is attached with the heat guiding plate 41. The heat guiding plate 41 has a first aperture 431 for corresponding to the first through hole 231 of the circuit board 21 and has a second aperture 432 for corresponding to the second through hole 241 of the circuit board 21, such that the first output electrode contact 341 is inserted into the first through hole 231 via the first aperture 431, and the second output electrode contact 342 is inserted into the second through hole 241 via the second aperture 432.

With reference to FIGS. 1 and 2, the radiating assembly 40 includes a heat guiding plate 41 made of aluminum or copper, an accommodating tube 44 for accommodating the heat guiding plate 41, plural cooling fins 45 surrounding around and retained with an outer side thereof, and a hollow room 42 defined in the accommodating tube 44; wherein a bottom end of the radiating assembly 40 is in connection with a lampshade 50 for protecting the plurality of light-emitting diodes 22.

Referring to FIG. 7, the electrically isolative connecting sleeve 16 of the electrical fitting 10a is coupled with an accommodating tube 44 of a radiating assembly 40. In addition, at least one input electrode contact of an electrical driving board 31 of a circuit module 30 is inserted into an electrode orifice of the first electricity conducting portion 13 or the second electricity conducting portion 14 and extends out of the electrical fitting 10a to conduct the power. For example, one of the at least one input electrode contact of an electrical driving board 31 is solder weld so that the electrical fitting 10a is electrically connected with the bulb holder, and the other of the at least one input electrode contact of the electrical driving board 31 is electrically coupled with one of the first electricity conducting portion 13 and the second electricity conducting portion 14 which does not have the electrode orifice.

For instance, the first electricity conducting portion 13 has a first electrode orifice 11 defined thereon, and a first input electrode contact 331 of the electrical driving board 31 of the circuit module 30 is inserted into the first electrode orifice 11 of the first electricity conducting portion 13 and extends out of the electrical fitting 10a, and a first electrode contact 331 of the electrical driving board 31 of the circuit module 30 is electrically connected with the second electricity conducting portion 14.

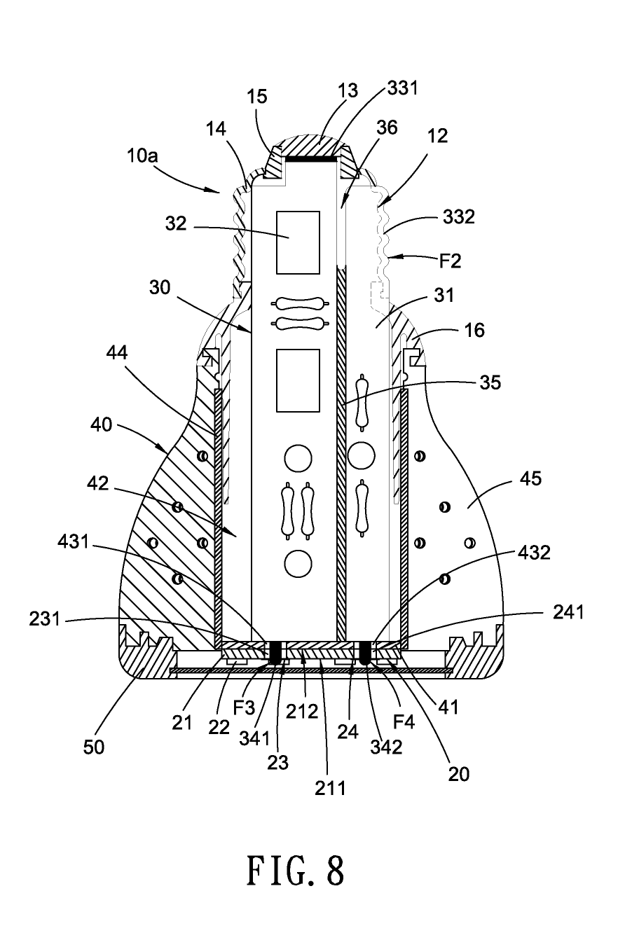

As illustrated in FIG. 8, in a sixth embodiment, a second electricity conducting portion 14 has a second electrode orifice 12 formed thereon, a second electrode contact 332 of an electrical driving board 31 of a circuit module 30 is inserted into a second electrode orifice 12 of the second electricity conducting portion 14 and extends out of an electrical fitting 10a, and a first electrode contact 331 of the electrical driving board 31 of the circuit module 30 is electrically connected with a first electricity conducting portion 13 of the electrical fitting 10a.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A light-emitting diode bulb being electrically connected with a bulb holder and comprising:
an electrical fitting electrically connecting with the bulb holder and including a first electricity conducting portion and a second electricity conducting portion electrically insulated from the first electricity conducting portion by an electricity insulating portion, the first electricity conducting portion and the second electricity conducting portion being electrically coupled with two power contacts, the electrical fitting also including at least one electrode orifice for inserting the first electricity conducting portion or the second electricity conducting portion;
an illuming assembly including a circuit board and a plurality of light-emitting diodes, the circuit board having a printed circuit electrically connected with the plurality of light-emitting diodes, and a first circuit contact and a second circuit contact which are both arranged on the printed circuit to conduct power to illuminate the plurality of light-emitting diodes;
a circuit module including an electrical driving board, a driving circuit portion formed on the electrical driving board, a first input electrode contact, a second input electrode contact, a first output electrode contact, and a second output electrode contact, the driving circuit portion being employed to convert the power and to control the power, such that the power of the bulb holder is transformed to illuminate the plurality of light-emitting diodes, one of the first input electrode contact and the second input electrode contact being inserted into the at least one electrode orifice of the electrical fitting and extending out of the electrical fitting to conduct the power, the other of the first input electrode contact and the second input electrode contact being electrically coupled with one of the first electricity conducting portion and the second electricity conducting portion which does not have the at least one electrode orifice, wherein the first output electrode contact and the second output electrode contact are electrically connected with a first circuit contact and a second circuit contact of the illuming assembly.

2. The light-emitting diode bulb as claimed in claim 1, wherein the electrical fitting is an Edison screw cap or a Bayonet cap.

3. The light-emitting diode bulb as claimed in claim 1, wherein the circuit board of the illuming assembly has a first through hole for corresponding to the first circuit contact and has a second through hole for corresponding to the second circuit contact, the first output electrode contact and the second output electrode contact are inserted into the first through hole and the second through hole of the illuming assembly, wherein the first output electrode contact and the second output electrode contact are welded with the first circuit contact and the second circuit contact.

4. The light-emitting diode bulb as claimed in claim 1, wherein the first input electrode contact and the second input electrode contact are a first protrusion and a second protrusion which are both formed on a first end of the electrical driving board, the first protrusion has a first edge, and the second protrusion has a second edge, wherein the first protrusion of the first input electrode contact and the second protrusion of the second input electrode contact are electrically connected with the driving circuit portion by ways of a conductive metal layer.

5. The light-emitting diode bulb as claimed in claim 1, wherein the first output electrode contact and the second output electrode contact are a third protrusion and a fourth protrusion which are both formed on a second end of the electrical driving board, the third protrusion has a third edge, and the fourth protrusion has a fourth edge, wherein the third protrusion of the first output electrode contact and the fourth protrusion of the second output electrode contact are electrically connected with the driving circuit portion by ways of a conductive metal layer.

6. The light-emitting diode bulb as claimed in claim 1, wherein the first output electrode contact and the second output electrode contact are electrically connected with the driving circuit portion by ways of metal terminals.

7. The light-emitting diode bulb as claimed in claim 1 further comprising a radiating assembly including a heat guiding plate, a hollow room, and an accommodating tube fixed in the hollow room, wherein the electrical fitting is mounted on one end of the radiating assembly, the circuit module is inserted into the hollow room, and the circuit board of the illuming assembly is joined with the heat guiding plate, such that heat of the illuming assembly is dissipated via the heat guiding plate.

8. The light-emitting diode bulb as claimed in claim 7, wherein the radiating assembly also includes plural cooling fins surrounding around and retained with an outer side thereof.

9. A light-emitting diode bulb being electrically connected with a bulb holder and comprising:
an electrical fitting electrically connecting with the bulb holder and including a first electrode orifice and a second electrode orifice which are both defined in the electrical fitting and correspond to two power contacts of the bulb holder;
an illuming assembly including a circuit board and a plurality of light-emitting diodes, the circuit board having a printed circuit electrically connected with the plurality of light-emitting diodes, and a first circuit contact and a second circuit contact which are both arranged on the printed circuit to conduct power to illuminate the plurality of light-emitting diodes;
a circuit module including an electrical driving board, a driving circuit portion formed on the electrical driving board, a first input electrode contact, a second input electrode contact, a first output electrode contact, and a second output electrode contact, the driving circuit portion being employed to convert the power and to control the power, such that the power of the bulb holder is transformed to illuminate the plurality of light-emitting diodes, the first input electrode contact of the circuit module being inserted into the first electrode orifice of the electrical fitting and extending out of the electrical fitting, and the second input electrode contact of the circuit module being inserted into the second electrode orifice of the electrical fitting and extending out of the electrical fitting, such that when the electrical fitting is electrically connected with the bulb holder, the first input electrode contact and the second input electrode contact of the circuit module electrically couple with the power of the bulb holder, wherein the first output electrode contact and the second output electrode contact are electrically connected with a first circuit contact and a second circuit contact of the illuming assembly.

10. The light-emitting diode bulb as claimed in claim 9, wherein the electrical fitting is an Edison screw cap or a Bayonet cap.

11. The light-emitting diode bulb as claimed in claim 9, wherein the electrical fitting is an electrical insulating element.

12. The light-emitting diode bulb as claimed in claim 9, wherein the electrical fitting electrically includes a first electricity conducting portion and a second electricity conducting portion electrically insulated from the first electricity conducting portion by an electricity insulating portion.

13. The light-emitting diode bulb as claimed in claim 9, wherein the circuit board of the illuming assembly has a first through hole for corresponding to the first circuit contact and has a second through hole for corresponding to the second circuit contact, the first output electrode contact and the second output electrode contact are inserted into the first through hole and the second through hole of the illuming assembly, wherein the first output electrode contact and the second output electrode contact are welded with the first circuit contact and the second circuit contact.

14. The light-emitting diode bulb as claimed in claim 9, wherein the first input electrode contact and the second input electrode contact are a first protrusion and a second protrusion which are both formed on a first end of the electrical driving board, the first protrusion has a first edge, and the second protrusion has a second edge, the first protrusion of the first input electrode contact and the second protrusion of the second input electrode contact are electrically connected with the driving circuit portion by ways of a conductive metal layer.

15. The light-emitting diode bulb as claimed in claim 9, wherein the first output electrode contact and the second output electrode contact are a third protrusion and a fourth protrusion which are both formed on a second end of the electrical driving board the third protrusion has a third edge, and the fourth protrusion has a fourth edge, wherein the third protrusion of the first output electrode contact and the fourth protrusion of the second output electrode contact are electrically connected with the driving circuit portion by ways of a conductive metal layer.

16. The light-emitting diode bulb as claimed in claim 9, wherein the first output electrode contact and the second output electrode contact are electrically connected with the driving circuit portion by ways of metal terminals.

17. The light-emitting diode bulb as claimed in claim 9 further comprising a radiating assembly including a heat guiding plate, a hollow room, and an accommodating tube fixed in the hollow room, wherein the electrical fitting is mounted on one end of the radiating assembly, the circuit module is inserted into the hollow room, and the circuit board of the illuming assembly is joined with the heat guiding plate, such that heat of the illuming assembly is dissipated via the heat guiding plate.

18. The light-emitting diode bulb as claimed in claim 17, wherein the radiating assembly also includes plural cooling fins surrounding around and retained with an outer side thereof.
